(19) United States
(12) Patent Application Publication
(10) Pub. No.: US 2021/0138995 A1
(43) Pub. Date: May 13, 2021

(54) AIRBAG TEAR STITCH PATTERNS AND RELATED METHODS

(71) Applicant: Autoliv ASP, Inc., Ogden, UT (US)

(72) Inventors: Troy Charles Stratton, Brigham City, UT (US); Stanton L. Brown, II, Salt Lake City, UT (US)

(21) Appl. No.: 16/681,529

(22) Filed: Nov. 12, 2019

(51) Int. Cl. B60R 21/2342; B60R 21/235

(52) U.S. Cl. CPC B60R 21/2342; B60R 2021/23509; B60R 21/235

(57) ABSTRACT

Airbag tear stitches, tear stitch patterns, and related airbag cushions. Some embodiments comprise an airbag cushion comprising a tear stitch, such as one or more tear stitches configured to rupture upon deployment of the airbag cushion. The tear stitch may comprise a first leg extending to a tip and a second leg extending to the tip. The airbag cushion may be configured such that a line intersects the first leg and the second leg at a first angle, the first angle being defined halfway between the first leg and the second leg. The line may be aligned with at least one directional load force to be experienced by the tear stitch during deployment of the airbag cushion.

### SUMMARY

Airbag cushions are often formed using one or more stitches configured to deliberately sever or break during use, such as break stitches temporarily holding various functional elements in place prior to a predetermined stage of airbag inflation, at which point these stitches are configured to intentionally fail to release adjacent fabric portions or other functional elements. However, use of such stitches often results in undesirable unraveling, typically at the ends of the stitching, during processing and/or use.

The present inventors have determined that it would be desirable to provide apparatus, systems, and methods that overcome one or more of the foregoing limitations and/or other limitations of the prior art. In some embodiments, the inventive concepts disclosed herein may therefore provide for tear stitching patterns that induce failure at the center of the stitches/stitch pattern rather than the ends. Preferred embodiments and sewing methods involving such shapes/patterns preferably involved non-straight stitching, such as stitching having a chevron shape or otherwise having pointed tips. Preferably, such tips are oriented towards the expected loading direction/zone to enhance performance. Forming stitching legs with relatively small angles therebetween to provide sharply pointed tips may further enhance desired performance characteristics.

In a more particular example of an airbag cushion according to some embodiments, the cushion may comprise a tear stitch configured to rupture upon deployment of the airbag cushion. The tear stitch may comprise an isolated stitch or may be part of a stitch pattern, such as a pattern having a series of repeating shapes or cycles. The tear stitch may comprise a first leg extending to a tip and a second leg extending to the tip. The airbag cushion may be configured such that a line intersecting the first leg and the second leg at a first angle, the first angle being defined halfway between the first leg and the second leg, is aligned with at least one directional load force to be experienced by the tear stitch during deployment of the airbag cushion.

In some embodiments, a second angle defined between the first leg and the second leg may be between about 10 degrees and about 120 degrees. In some such embodiments, the second angle may be between about 20 degrees and about 45 degrees.

Some embodiments may comprise a repeating tear stitch pattern, such as a repeating stitch pattern comprising a plurality of tips, wherein each tip of the plurality of tips is formed by two adjacent legs. In some such embodiments, the repeating tear stitch pattern may comprise a plurality of opposing tips formed opposite the plurality of tips such that the repeating tear stitch pattern forms a zig-zag pattern. Alternatively, the repeating tear stitch pattern may comprise a plurality of curved portions formed between adjacent legs opposite the plurality of tips. For example, the repeating tear stitch pattern may comprise, or at least substantially comprise, a sinusoidal shape along a side of the pattern opposed to the plurality of tips and may comprise a plurality of pointed tips along a side of the pattern opposed to the side comprising the sinusoidal shape.

In an example of an airbag cushion according to some embodiments, the airbag cushion may comprise a first fabric portion and a second fabric portion. Tear stitching may be used to couple the first fabric portion with the second fabric portion. In some embodiments, the tear stitching may comprise an oscillating pattern, such as an oscillating pattern comprising a chevron shape having a plurality of legs interconnected by opposing legs.

In some embodiments, the tear stitching may be configured to rupture upon deployment of the airbag cushion, such as at a predefined stage during airbag inflation.

In some embodiments, the first fabric portion may comprise a first fabric piece, and the second fabric portion may comprise a second fabric piece separate from the first fabric piece.

In some embodiments, the first fabric portion may be positioned in the same plane as the second fabric portion, such as end to end, and the tear stitching may keep the fabric portions temporarily connected.

In some embodiments, the airbag cushion may be configured such that at least some of the directional load forces to be experienced by the tear stitching during deployment of the airbag cushion are aligned with each line of a plurality of lines intersecting each pair of adjacent legs of the plurality of legs at midpoints between each of the adjacent legs.

In an example of a method for applying a tear stitch to an airbag cushion according to some implementations, the method may comprise positioning a first fabric portion adjacent to a second fabric portion and applying a tear stitch to couple the first fabric portion to the second fabric portion. The tear stitch may comprise a pointed tip defined by interconnecting legs. The method may further comprise generating a force to sever the tear stitch and separate the first fabric portion from the second fabric portion, the force being in a direction at least substantially aligned with a line intersecting the interconnecting legs along an angle at a midpoint therebetween. This force may be generated, for example, automatically during deployment of the airbag cushion and therefore the direction of the pointed tip may be selected accordingly. In other embodiments, the force may be generated during an expected handling step during assembly, manufacturing, and/or processing of the airbag cushion.

In some implementations, the step of positioning a first fabric portion adjacent to a second fabric portion may comprise positioning the first fabric portion in an overlapping configuration vis-à-vis the second fabric portion and/or an edge-to-edge configuration vis-à-vis the second fabric portion.

In some implementations, the force may be part of a directional load zone comprising a series of directional forces directed towards the pointed tip. The directional load zone may comprise opposing borders outside of which at least substantially no forces are received during the step of generating a force to sever the tear stitch.

In some implementations, both of the angles between each of the opposing borders and an adjacent leg of the interconnecting legs are at least 120 degrees.

In some implementations, the step of applying a tear stitch to couple the first fabric portion to the second fabric portion may comprise applying a tear stitch pattern comprising a series of repeating tear stitch cycles, wherein each cycle of the repeating tear stitch cycles comprises a pointed tip defined by interconnecting legs. In some such embodiments, the tear stitch pattern may comprise a chevron pattern comprising a plurality of pointed tips pointed in opposing directions.

The features, structures, steps, or characteristics disclosed herein in connection with one embodiment may be combined in any suitable manner in one or more alternative embodiments.

### BRIEF DESCRIPTION OF THE DRAWINGS

Non-limiting and non-exhaustive embodiments of the disclosure are described, including various embodiments of the disclosure with reference to the figures, in which:

FIG. 1 depicts a tear stitching pattern for use in airbag cushions according to some embodiments;

FIGS. 2A-2C depict various configurations of a tear stitch during application of a peel load thereto;

FIG. 3 depicts a tear stitch tilted relative to a central axis of an adjacent load zone according to some embodiments and implementations; and

FIG. 4 depicts a tear stitching pattern for use in airbag cushions according to other embodiments.

### DETAILED DESCRIPTION

A detailed description of apparatus, systems, and methods consistent with various embodiments of the present disclosure is provided below. While several embodiments are described, it should be understood that the disclosure is not limited to any of the specific embodiments disclosed, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

As used herein, the term “substantially” refers to the complete or nearly complete extent or degree of an action, characteristic, property, state, structure, item, or result to function as indicated. For example, an object that is “substantially” cylindrical or “substantially” perpendicular would mean that the object/feature is either cylindrical/perpendicular or nearly cylindrical/perpendicular so as to result in the same or nearly the same function. The exact allowable degree of deviation provided by this term may depend on the specific context. The use of “substantially” is equally applicable when used in a negative connotation to refer to the complete or near complete lack of an action, characteristic, property, state, structure, item, or result. For example, structure which is “substantially free of” a bottom would either completely lack a bottom or so nearly completely lack a bottom that the effect would be effectively the same as if it completely lacked a bottom.

Similarly, as used herein, the term “about” is used to provide flexibility to a numerical range endpoint by providing that a given value may be “a little above” or “a little below” the endpoint while still accomplishing the function associated with the range.

The embodiments of the disclosure may be best understood by reference to the drawings, wherein like parts may be designated by like numerals. It will be readily understood that the components of the disclosed embodiments, as generally described and illustrated in the figures herein, could be arranged and designed in a wide variety of different configurations. Thus, the following detailed description of the embodiments of the apparatus and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified. Additional details regarding certain preferred embodiments and implementations will now be described in greater detail with reference to the accompanying drawings.

FIG. 1 depicts an airbag cushion 60 comprising tear stitching 100 formed in a repeating pattern. Tear stitching 100 is configured to rupture upon deployment of the airbag cushion 60 and comprises a pattern made up of a series of repeating stiches, each of which comprises a first leg 102 and a second leg 104 extending to a tip (the tip pointing in the downward direction in FIG. 1). An angle α is formed between first leg 102 and second leg 104. In some embodiments, angle α may be between about 10 degrees and about 120 degrees. In more preferred embodiments, angle α may be between about 20 degrees and about 45 degrees.

It should be understood that the tear stitches shown in the pattern of FIG. 1 may be applied to multiple layers of fabric making up airbag cushion 60 or may be applied to adjacent fabric portions and/or layers positioned adjacent to one another rather than layered on top of one another. A wide variety of uses for such tear stitches are also contemplated, as those of ordinary skill in the art will appreciate, such as uses in connection with tethers, vents, flaps, baffles, and the like, for example.

It should also be understood that any of the various stitches and/or stitch patterns described herein may be formed using, for example, a single thread that changes direction at the tip and/or apex or, alternatively, by separate threads that join together at the tip/apex.

In some embodiments and implementations, the tear stitch/stitching may be used to temporarily hold a first fabric portion in place relative to a second fabric portion. In some embodiments, the first and second fabric portions may comprise separate fabric pieces. Alternatively, they may comprise portions of a single piece of fabric, such as to hold a fold in place made by folding a piece of fabric back onto itself.

In addition, although the side opposite the aforementioned tips also forms tips in the depicted embodiment, such that a zig-zag pattern is formed, it should be understood that, in alternative embodiments, a side opposite the aforementioned tip need not form a similar tip. Instead, as discussed in greater detail below, the opposite side may be curved and/or rounded rather than pointed. Similarly, in some embodiments and implementations, a single stitch may be used rather than a repeating pattern as shown in FIG. 1.

It may be important, however, for certain applications and embodiments, for at least one side to form a tip similar to those depicted in FIG. 1. It may also be preferred that this tip be directed towards an anticipated lading direction (within one or more preferred angle ranges). For example, in some embodiments, an airbag cushion having such tear stitching may be configured such that a line intersecting the first leg 102 and the second leg 104 at midpoint between the first leg and the second leg (in other words, half the angle α), is aligned with at least one directional load force to be experienced by the tear stitch during normal use, such as during deployment of the airbag cushion in some embodiments and/or during handling of the airbag cushion during installation and/or assembly, for example. In some embodiments, this line may be no more than about 30 degrees from at least one directional load force to be experience by the tear stitch during normal use.

FIGS. 2A-2C depict various embodiments of stitch 100, which, again, may be defined by opposing legs 102 and 104 that are interconnected at a tip, along with an adjacent load zone 50 within which stitch 100 is expected to experience loading/forces during use, such as during inflation of airbag cushion 60. As shown in each of these figures, and angle α is formed between legs 102 and 104 and angles 13 are formed between each leg 102/104 and an edge of the adjacent load zone 50. In these depicted embodiments, the tip of the tear stitch 100 is aligned with a center of the load zone 50. However, this need not be the case with all embodiments, as discussed in greater detail below.

As suggested by the various exemplary angles depicted in FIGS. 2A-2C, it is preferred that legs 102/104 be formed with a relatively small angle α therebetween, as ideally loading should at least substantially occur such that the outer perimeter of the expected load zone 50 is spaced apart from one, or even more preferably both, adjacent legs 102/104. In other words, angles 13, which are shown to be identical adjacent to both legs 102/104 but need not be identical in all embodiments/applications, are preferably at least about 120 degrees. Thus, providing a smaller angle α (again, in preferred embodiments between about 10 degrees and about 120 degrees and, in more preferred embodiments, between about 20 degrees and about 45 degrees) may allow for improving functionality of the stitch 100 by, for example, reducing unwanted thread unraveling and/or providing induced center loading as opposed to end loading.

FIG. 3 depicts stitch 100 in a configuration in which the center of the resulting tip is misaligned with the adjacent load zone/direction 50. Thus, an angle β is formed between the primary direction of load 50 and leg 102 and another angle θ is formed between the primary direction of load 50 and leg 104. It should be understood that load 50 may comprise a load zone including forces from multiple directions pointing towards the tip between leg 102 and leg 104, as mentioned above. In some embodiments and implementations, at least one of angles β and θ is at least 120 degrees. In some such embodiments and implementations, both of angles 13 and 8 may be at least 120 degrees.

FIG. 4 depicts an alternative stitching pattern 400 comprising a plurality of repeating tear stitches. However, in the depicted embodiment of FIG. 4, each of the adjacent legs, such as legs 402 and 404 forms a pointed, directional tip at the end adjacent to an expected load zone/direction (the bottom from the perspective of FIG. 4) and, rather than forming similar pointed tips at the opposite end as previously discussed, forms a plurality of curved portions opposite the plurality of tips. Patterns having pointed tips directed towards expected loading such as the one depicted in FIG. 4 may provide similar benefits by inducing loading within a center or central portion of the stitch/stitching pattern rather than towards the end or ends. The depicted embodiment comprises a sinusoidal shape along a side of the pattern opposed to the plurality of tips formed by adjacent legs. However, a wide variety of alternative shapes/designs for the stitching are contemplated, preferably so long as a pointed tip is formed to be directed towards the expected load/loading zone, or at least within a range of this direction, as described herein.

In some embodiments, the airbag cushion may be configured such that at least some of the directional load forces to be experienced by the tear stitching during deployment of the airbag cushion are no more than about 30 degrees from each line of a plurality of lines intersecting each pair of adjacent legs of the plurality of legs at midpoints between each of the adjacent legs. In some such embodiments, at least some of the directional load forces to be experienced by the tear stitching during deployment of the airbag cushion are aligned with each line of a plurality of lines intersecting each pair of adjacent legs of the plurality of legs at midpoints between each of the adjacent legs.

In some exemplary methods involving the inventive principles disclosed herein, the method may comprise applying one or more tear/break stitches to an airbag cushion and may comprise positioning a first fabric portion adjacent to a second fabric portion and applying a tear stitch to couple the first fabric portion to the second fabric portion. Preferably, the tear stitch(es) comprises a pointed tip defined by interconnecting legs. A force may be generated to sever the tear stitch and separate the first fabric portion from the second fabric portion. The force is preferably in a direction at least substantially aligned with a line intersecting the interconnecting legs along an angle at a midpoint therebetween and/or in a direction no more than about 120 degrees from one or both legs of the tear stitch(es).

In some implementations, the first fabric portion may be overlapped vis-à-vis the second fabric portion and the tear stitching may be applied to temporarily maintain this overlapping configuration. Alternatively, the step of positioning a first fabric portion adjacent to a second fabric portion may comprise positioning the first fabric portion in an edge-to-edge configuration vis-à-vis the second fabric portion.

In some implementations, the force may be part of a directional load zone comprising a series of directional forces directed towards the pointed tip. In some such implementations, the directional load zone may comprise opposing borders outside of which at least substantially no forces are received by the tip(s) during the step of generating a force to sever the tear stitch.

The step of applying a tear stitch to couple the first fabric portion to the second fabric portion may comprise applying a tear stitch pattern comprising a series of repeating tear stitch cycles, wherein each cycle of the repeating tear stitch cycles comprises a pointed tip defined by interconnecting legs. In some such methods, the tear stitch pattern may comprise a chevron pattern comprising a plurality of pointed tips pointed in opposing directions.

The foregoing specification has been described with reference to various embodiments and implementations. However, one of ordinary skill in the art will appreciate that various modifications and changes can be made without departing from the scope of the present disclosure. For example, various operational steps, as well as components for carrying out operational steps, may be implemented in various ways depending upon the particular application or in consideration of any number of cost functions associated with the operation of the system. Accordingly, any one or more of the steps may be deleted, modified, or combined with other steps. Further, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced, are not to be construed as a critical, a required, or an essential feature or element.

Those having skill in the art will appreciate that many changes may be made to the details of the above-described embodiments without departing from the underlying principles of the invention. The scope of the present invention should, therefore, be determined only by the following claims.

1. An airbag cushion, comprising:
a tear stitch configured to rupture upon deployment of the airbag cushion, wherein the tear stitch comprises:
a first leg extending to a tip; and
a second leg extending to the tip, wherein the airbag cushion is configured such that a line intersecting the first leg and the second leg at a first angle, the first angle being defined halfway between the first leg and the second leg, is aligned with at least one directional load force to be experienced by the tear stitch during deployment of the airbag cushion.

2. The airbag cushion of claim 1, wherein a second angle defined between the first leg and the second leg is between about 10 degrees and about 120 degrees.

3. The airbag cushion of claim 2, wherein the second angle is between about 20 degrees and about 45 degrees.

4. The airbag cushion of claim 1, wherein the tear stitch comprises a repeating tear stitch pattern.

5. The airbag cushion of claim 4, wherein the repeating tear stitch pattern comprises a plurality of tips, wherein each tip of the plurality of tips is formed by two adjacent legs.

6. The airbag cushion of claim 5, wherein the repeating tear stitch pattern comprises a plurality of opposing tips formed opposite the plurality of tips such that the repeating tear stitch pattern forms a zig-zag pattern.

7. The airbag cushion of claim 5, wherein the repeating tear stitch pattern comprises a plurality of curved portions formed between adjacent legs opposite the plurality of tips.

8. The airbag cushion of claim 5, wherein the repeating tear stitch pattern at least substantially comprises a sinusoidal shape along a side of the pattern opposed to the plurality of tips, and wherein the repeating tear stitch pattern comprises a plurality of pointed tips along a side of the pattern opposed to the side comprising the sinusoidal shape.

9. An airbag cushion, comprising:
a first fabric portion;
a second fabric portion; and
tear stitching coupling the first fabric portion with the second fabric portion, wherein the tear stitching comprises an oscillating pattern, the oscillating pattern comprising a chevron shape having a plurality of legs interconnected by opposing legs.

10. The airbag cushion of claim 9, wherein the tear stitching is configured to rupture upon deployment of the airbag cushion.

11. The airbag cushion of claim 9, wherein the first fabric portion comprises a first fabric piece, and wherein the second fabric portion comprises a second fabric piece separate from the first fabric piece.

12. The airbag cushion of claim 9, wherein the first fabric portion is positioned in the same plane as the second fabric portion.

13. The airbag cushion of claim 12, wherein the airbag cushion is configured such that at least some of the directional load forces to be experienced by the tear stitching during deployment of the airbag cushion are aligned with each line of a plurality of lines intersecting each pair of adjacent legs of the plurality of legs at midpoints between each of the adjacent legs.

14. A method for applying a tear stitch to an airbag cushion, the method comprising the steps of:
positioning a first fabric portion adjacent to a second fabric portion;
applying a tear stitch to couple the first fabric portion to the second fabric portion, wherein the tear stitch comprises a pointed tip defined by interconnecting legs; and
generating a force to sever the tear stitch and separate the first fabric portion from the second fabric portion, the force being in a direction at least substantially aligned with a line intersecting the interconnecting legs along an angle at a midpoint therebetween.

15. The method of claim 14, wherein the step of positioning a first fabric portion adjacent to a second fabric portion comprises positioning the first fabric portion in an overlapping configuration vis-à-vis the second fabric portion.

16. The method of claim 14, wherein the step of positioning a first fabric portion adjacent to a second fabric portion comprises positioning the first fabric portion in an edge-to-edge configuration vis-à-vis the second fabric portion.

17. The method of claim 14, wherein the force is part of a directional load zone comprising a series of directional forces directed towards the pointed tip, wherein the directional load zone comprises opposing borders outside of which at least substantially no forces are received during the step of generating a force to sever the tear stitch.

18. The method of claim 17, wherein both of the angles between each of the opposing borders and an adjacent leg of the interconnecting legs are at least 120 degrees.

19. The method of claim 14, wherein the step of applying a tear stitch to couple the first fabric portion to the second fabric portion comprises applying a tear stitch pattern comprising a series of repeating tear stitch cycles, wherein each cycle of the repeating tear stitch cycles comprises a pointed tip defined by interconnecting legs.

20. The method of claim 19, wherein the tear stitch pattern comprises a chevron pattern comprising a plurality of pointed tips pointed in opposing directions.
